(19) United States
(12) Patent Application Publication
(10) Pub. No.: US 2026/0181541 A1
(43) Pub. Date: Jun. 25, 2026

(54) DISTRIBUTED RADIO RESOURCE ORCHESTRATION FOR NETWORK SLICING

(71) Applicant: AT&T Intellectual Property I, L.P., Atlanta, GA (US)

(72) Inventors: Joseph Soryal, Glendale, NY (US); Neel Patel, Short Hills, NJ (US); Venson Shaw, Kirkland, WA (US)

(21) Appl. No.: 18/988,864

(22) Filed: Dec. 19, 2024

(51) Int. Cl. H04W 48/18; H04W 72/53

(52) U.S. Cl. CPC H04W 48/18; H04W 72/53

(57) ABSTRACT

An example method for distributed radio resource orchestration for network slicing includes detecting, from within a radio access network of a communication service provider network, a need of a user endpoint device to access an improved quality of service, defining, in response to the detecting and in coordination with at least one other processing system in the radio access network, a set of radio resources to support the improved quality of service for the user endpoint device, configuring the set of radio resources as a slice of the communication service provider network, and sending an instruction to the user endpoint device that causes the user endpoint device to connect to the slice.

The present disclosure relates generally to cellular communication networks,
and more particularly to methods, non-transitory computer-readable media, and apparatuses for distributed radio resource orchestration for network slicing.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Ultimately, 5G may deliver superior high speed and performance.

### SUMMARY

In one example, the present disclosure discloses a method, computer-readable medium, and apparatus for distributed radio resource orchestration for network slicing. For example, a method performed by a processing system including at least one processor may include detecting, from within a radio access network of a communication service provider network, a need of a user endpoint device to access an improved quality of service, defining, in response to the detecting and in coordination with at least one other processing system in the radio access network, a set of radio resources to support the improved quality of service for the user endpoint device, configuring the set of radio resources as a slice of the communication service provider network, and sending an instruction to the user endpoint device that causes the user endpoint device to connect to the slice.

In another example, a non-transitory computer readable storage medium may store instructions which, when executed by a processing system including at least one processor, cause the processing system to perform operations. The operations may include detecting, from within a radio access network of a communication service provider network, a need of a user endpoint device to access an improved quality of service, defining, in response to the detecting and in coordination with at least one other processing system in the radio access network, a set of radio resources to support the improved quality of service for the user endpoint device, configuring the set of radio resources as a slice of the communication service provider network, and sending an instruction to the user endpoint device that causes the user endpoint device to connect to the slice.

In another example, an apparatus may include a processing system including at least one processor and a non-transitory computer readable storage medium storing instructions which, when executed by the processing system, cause the processing system to perform operations. The operations may include detecting, from within a radio access network of a communication service provider network, a need of a user endpoint device to access an improved quality of service, defining, in response to the detecting and in coordination with at least one other processing system in the radio access network, a set of radio resources to support the improved quality of service for the user endpoint device, configuring the set of radio resources as a slice of the communication service provider network, and sending an instruction to the user endpoint device that causes the user endpoint device to connect to the slice.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for distributed radio resource orchestration for network slicing, according to the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for distributed radio resource orchestration for network slicing. In particular, in 5G and upcoming 6G networks, network slicing is one of the defining features relating to quality of service (QoS) parameters and user experience measures. For example, a cellular network may utilize network slicing, e.g., as described/defined in 3GPP technical standard (TS) 23.501, and may therefore be comprised of many slices, each with different characteristics. In addition, such a cellular network may include a slice orchestrator, such as described in 3GPP TS 28.530 and/or 28.531.

Currently, three main types of slicing are used: radio resource partitioning (RRP), user equipment routing selection policy (URSP), and traditional slicing. RRP achieves isolation and sharing of radio resources among network slices by isolating the radio resources into partitions that can be dynamically associated per network slice. Thus, RRP applies only to over-the-air resources and can work based on the public land mobile network (PLMN) or frequency band. RRP is typically controlled by a baseband unit (BBU). URSP relies in the user equipment (UE) initiating a request for slicing on a per-application basis, which triggers the slicing request based on a policy control function (PCF) profile flag. Traditional slicing involves the over-the-air resources stitched with the transport and core layers of the wireless network.

Slicing decisions are typically made based on geographical location to best serve the wireless customers in a specific geographic area, and the formation and management of the slices tend to happen at the local level. However, the slicing decisions do not tend to consider the radio physical layer (e.g., the radio access network), but only the cellular core network.

Examples of the present disclosure introduce a distributed slicing manager (DSM), which may be implemented in a RAN intelligent controller (RIC), to monitor the user endpoint devices connected to a RAN, the QoS requirements associated with the user endpoint devices, the behaviors of the user endpoint devices (e.g., in terms of types of traffic and/or applications being served), and mobility trajectories of the user endpoint devices. The DSM may cooperate with DSMs of other RICs to construct a dynamic map of the paths used in a communication service provider network, traffic in the communication service provider network, QoS requirements of the user endpoint devices, and the like. Based on this dynamic map, the DSM may define one or more network slices for use by the user endpoint devices.

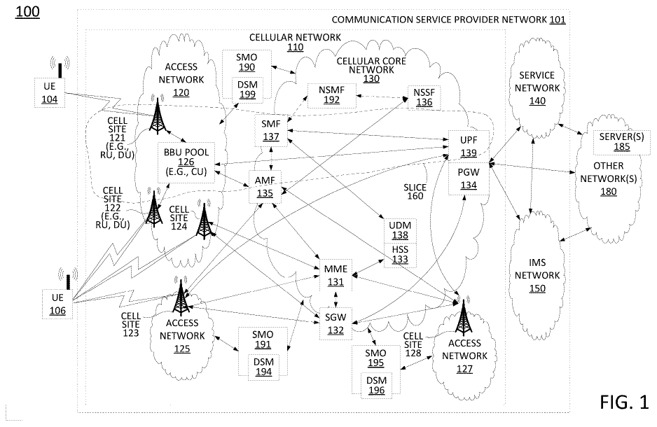

In further examples, multiple DSMs serving neighboring cells may form clusters to ensure that once one DSM defines a network slice for a user endpoint device, comparable network slices can continue to be provided as the user endpoint device moves between cells of the communication service provider network. These and other aspects of the present disclosure are discussed in greater detail below in connection with the examples of FIGS. 1-3.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises one or more access networks 120, 125, and 127 and a cellular core network 130. In one example, at least one of the access networks 120, 125, and 127 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

In one example, access networks 125 and 127 may be configured in a manner similar to access network 120. For ease of illustration, however, most of the details of access networks 125 and 127 are omitted. However, FIG. 1 does illustrate a cell site 123 in access network 125 and a cell site 128 in access network 127.

Although cloud RAN and or O-RAN infrastructure may include radio units (RUs)/RRHs, distributed units (DUs), and centralized units (CU) (e.g., where baseband units (BBUs) may include CUs and/or CUs in conjunction with DUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-124 or 128 may be deployed with antenna and radio infrastructures, including multiple input multiple output (MIMO) and millimeter wave antennas.

In one example, any of the access networks 120, 125, and 127 may include both 4G/LTE and 5G radio access network infrastructure. For example, access network 125 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 124 may include both 4G and 5G base station equipment and corresponding connections to 4G and 5G components in cellular core network 130. Although the access networks 120, 125, and 127 are illustrated as including both 4G and 5G components, in another example, 4G and 5G components may be considered to be contained within different access networks. Nevertheless, such different access networks may have a same wireless coverage area, or fully or partially overlapping coverage areas. In accordance with the present disclosure, a base station may comprise one of cell sites 121-124. Alternatively, or in addition, a base station may comprise one of baseband units within BBU pool 126 or a portion thereof (e.g., a CU, a DU, or a CU in conjunction with a DU), or a BBU of BBU pool 126 in conjunction with an RU or RRH of one of cell sites 121-124.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126. In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-124 and 127. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and any future generation of wireless cellular technology, e.g., 6G the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, a network slice management function (NSMF) 192.

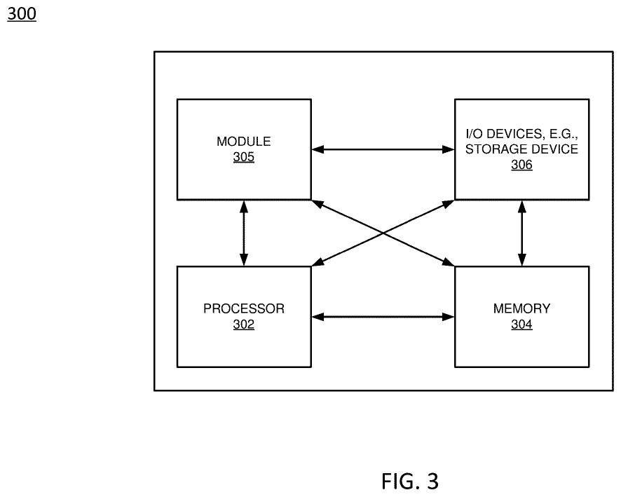

In one example, NSMF 192 may comprise all or a portion of a computing device or system, such as computing system 300, and/or processing system 302 as described in connection with FIG. 3 below, and may be configured to perform various operations in connection with examples of the present disclosure for distributed radio resource orchestration for network slicing (e.g., as illustrated and described in connection with the example of FIG. 3). In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. In a further example, the network slice may additionally comprise a set of access network components, e.g., CUs, DUs, RUs, and so forth.

A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth. As noted above, in accordance with the present disclosure, network slices may also be requested and instantiated on an individualized basis, e.g., a dedicated network slice for an enterprise (e.g., one or more servers hosting client facing services and/or for virtual private network (VPN) support via dedicated network slice(s), etc.) and/or for individuals (e.g., UEs that may seek to communicate with remote counterparties, which may include other UEs, enterprise servers, etc.). Network slices may also be instantiated in a predictive manner, to respond to observed or predicted network conditions, real world conditions such as natural disasters, vehicular accidents, and large-scale events, and the like. In one example, NSSF 136 may communicate with AMF 135 to provide the authorization for a UE to access a particular network slice, such as a dedicated/individualized network slice as described herein.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

In one example, cellular network 110 may comprise a “non-stand alone” (NSA) mode architecture, where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, in another example, the present disclosure may relate to a hybrid, or integrated 4G/LTE-5G cellular core network, such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure. As illustrated in FIG. 1, other networks 180 may include one or more servers 185. For example, server(s) 185 may participate in communication sessions with client devices, such as user equipment (UE) 104 and 106 via one or more dedicated network slices (e.g., individualized network slices) as described herein.

FIG. 1 also illustrates various mobile/cellular endpoint devices, e.g., user equipment (UE) 104 and 106. UE 104 and 106 may each comprise a cellular telephone, a smartphone, a tablet computing device, a laptop computer, a pair of computing glasses, a pair of wireless goggles, a wireless enabled wristwatch, a wireless transceiver for a fixed wireless broadband (FWB) deployment, or any other cellular-capable mobile telephony and computing devices (broadly, “a mobile endpoint device” or “cellular endpoint device”) In one example, each of the UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of the UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

As illustrated in FIG. 1, UEs 104 and 106 may register and attach to any of cell sites 121-124 and 128 to obtain network services from cellular network 110 and/or communication service provider network 101. This may include detecting a primary synchronization signal (PSS), secondary synchronization signal (SSS), physical broadcast channel (PBCH), and/or demodulation reference signal (DMRS), engaging a random access channel to report to the selected cell site and establish a radio resource control (RRC) communication, transmitting a registration/attach request, performing authentication procedures, establishing a default protocol data unit (PDU) session, e.g., including bearer assignment, and so forth.

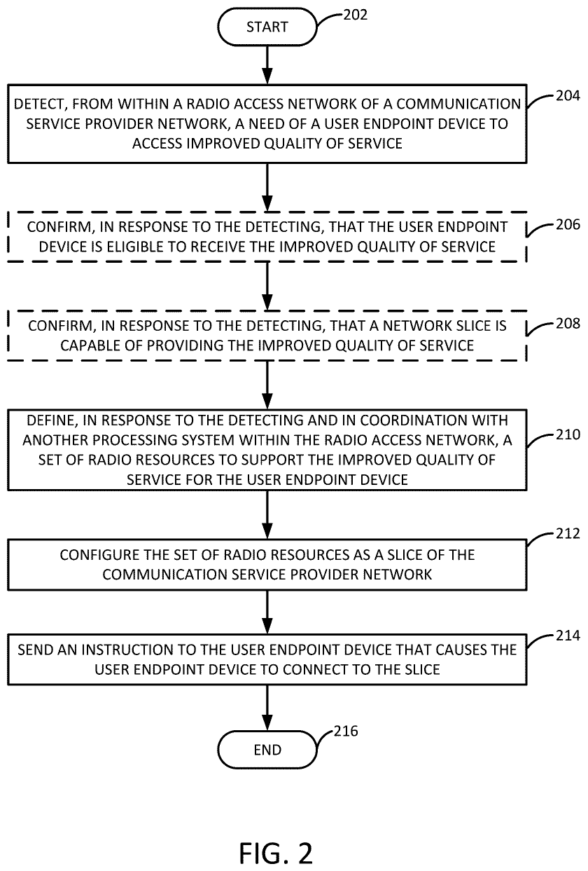

In one example, UEs 104 and 106, and/or server(s) 185 may each comprise all or a portion of a computing device or system, such as computing system 300, and/or processing system 302 as described in connection with FIG. 3 below, and may be configured to perform various operations in connection with examples of the present disclosure for distributed radio resource orchestration for network slicing (e.g., as illustrated and described in connection with the example of FIG. 2).

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NSMF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrators (SMOs) 190, 191, and 195. For instance, in one example, each SMO 190, 191, and 195 may comprise a self-optimizing network (SON) orchestrator and/or software defined network (SDN) controller. To illustrate, each SMO 190, 191, and 195 may function as a self-optimizing network (SON) orchestrator that is responsible for activating and deactivating, allocating and deallocating, and otherwise managing a variety of network components. For instance, each SMO 190, 191, and 195 may activate and deactivate antennas/remote radio heads of cell sites 121 and 122 (or other cell sites served by the SMOs 190, 191, and 195), respectively, may allocate and deactivate baseband units in BBU pool 126 (or other BBU pools served by the SMOs 190, 191, and 195), and may perform other operations for activating antennas based upon a location and a movement of an endpoint device or a group of endpoint devices, in accordance with the present disclosure.

In one example, each SMO 190, 191, and195 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node, such as a virtual AMF (vAMF), a virtual SMF (vSMF), a virtual UPF (vUPF), virtual centralized unit (vCU), virtual distributed unit (vDU), virtual radio unit (vRU), etc. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, each the SMO 190, 191, and 195 may be connected directly or indirectly to any one or more network elements of cellular core network 130, access networks 120, 125, 127 and of the system 100 in general. Due to the relatively large number of connections available between each SMO 190, 191, and 195 and other network elements, none of the actual links to the SON/SDN controllers 190, 191, and 195 are shown in FIG. 1. Similarly, intermediate devices and links between MME 131, SGW 132, cell sites 121-124, PGW 134, AMF 135, NSSF 136, SMF 137, UDM 138, NSMF 192, and/or UPF 139, and other components of system 100 are also omitted for clarity, such as additional routers, switches, gateways, and the like.

In one example, each SMO 190, 191, and 195 may include a RAN intelligent controller (RAN-IC or RIC). For instance, in an O-RAN architecture, the RIC may be deployed for managing and controlling various RAN components/functions, e.g., CUs, DUs, and RUs. For instance, a RIC may comprise a platform that hosts various RAN applications (e.g., xApps/rApps) that may be used to configure and reconfigure various components of access networks 120, 125, 127. In one example, aspects of RIC may represent functionality of an SON orchestrator, or vice versa.

In one example, an instance of a distributed slice management (DSM) function 194, 196, or 199 may be instantiated on each RIC. The DSMs 194, 196, and 199 may comprise real time applications that collaborate across the access networks 120, 125, and 127 and share information including: connected UEs (e.g., UEs 104, 106, and others) and the QoS requirements of the connected UEs, behaviors of the connected UEs (e.g., in terms of types of traffic and/or applications being served to the UEs), and mobility trajectories of the connected UEs. Over time, each DSM 194, 196, and 199 may construct a dynamic map of the system 100 that maps out paths used, traffic/network resource consumption, QoS requirements, and other measurements of network usage and performance. DSMs 194, 196, and 199 may examine UE traffic and call detail records (CDRs) to determine whether UEs are receiving contracted-for QoS, and to determine whether any UEs may be eligible to be moved to one or more network slices that provide improved QoS.

In one example, DSMs 194, 196, and 199 may form clusters with DSMs serving neighboring cells of access networks 120, 125, and 127. Some clusters may overlap in the sense that a given DSM 194, 196, or 199 may belong to more than one cluster. The formation of clusters may allow the DSMs 194, 196, and 199 to provide UEs (e.g., UEs 104 and 106 and other UEs) with the same QoS across a larger geographical area, while also coordinating the needs of other UEs and balancing the available bandwidth in the larger geographical area.

In an illustrative example, UE 104 may establish a communication session or may seek to establish a communication session with one of the server(s) 185. However, in one example, UE 104 may first initiate a communication to DSM 199 to request improved QoS for the communication session. Alternatively, the DSM 199 may predict, based on one or more observed or predicted conditions, that improved QoS for the communication session may be necessary. For instance, the UE 104 may be attempting to establish the communication session from a physical location at which there is network congestion due to a large number of users (e.g., as may be the case at a concert, and sports event, a festival, or the like), from a physical location at which an emergency is occurring (e.g., a natural disaster, a vehicular accident, or the like), or the like. In another example, the server 185 with which the UE 104 is attempting to establish the communication session may be associated with an application or service for which higher QoS is necessary (e.g., first response/emergency services, monitoring of medical data and conditions, transmission of financial data, or the like).

In examples where the UE 104 is requesting the improved QoS, DSM 199 may authenticate UE 104 and/or a user thereof, e.g., based on the international mobile equipment identity (IMEI) or the like, based on a user entry of a password via UE 104 that is conveyed to DSM 199 in connection with the request, etc. In one example, the request may include preferred network slice characteristics/parameters (e.g., minimum guaranteed bandwidth, throughput, latency, additional security features (such geographic restrictions of VNFs allocated to the slice, etc.), and so forth. Alternatively, or in addition, the request may indicate the intended counterparty to the communication session (e.g., the one of server(s) 185). For example, server(s) 185 may represent an online banking system, a healthcare provider system, or the like, where the operating entity may have a preexisting arrangement with the communication service provider network 101 for the use of dedicated network slices for client communication sessions, e.g., with a particular service level agreement (SLA) having target performance indicator metrics (e.g., minimum bandwidth and/or minimum throughput, maximum latency, etc.).

In any case, DSM 199 may verify UE 104 and/or the user thereof. For instance, this may include DSM 199 referring to UDM 138 or the like to extract a user profile or UE profile to determine that the user and/or UE 104 is entitled to utilize a dedicated slice. In one example, the data in UDM 138 may further indicate a SLA, which may include network slice characteristics/parameters to which the user and/or UE 104 may be entitled (or alternatively, to which the server(s) 185 may be entitled to offer to its clients). Assuming that the UE 104 and/or user is authenticated, the DSM 199 may then proceed to reserve network resources and to create the network slice along the route (e.g., RAN, cellular core, and/or transport network, etc.). For instance, DSM 199 may arrange a slice 160 (e.g., a network slice, or “slice instance,” comprising AMF 135, SMF 137, UPF 139, etc.). In one example, any one or more of these NFs may comprise a VNF. In one example, DSM 199 may work in conjunction with other DSMs 194 and 196 to ensure the provisioning of slice 160. For instance, SMOs 191 or 195 associated with DSMs 194 or 196 may instantiate VNFs as an AMF 135, SMF 137, UPF 139, etc., while DSM 199 may configure the VNFs to operate as an integrated slice. In one example, the network slice 160 may further include RAN resources (e.g., a CU, a DU, and/or an RU, or the like, e.g., represented by BBU pool 126 and/or one cell sites 121), transport network resources, e.g., between access networks 120, 125, and 127 and cellular core network 130, and so forth. In one example, DSM 199 may provide to NSSF 136 information about the slice 160, as well as the entities authorized to use the slice 160.

In one example, UE 104 and the one of the server(s) 185 may begin communicating via the slice 160 (e.g., transmitting and/or receiving data packets). In one example, the DSM 199 may analyze the network performance indicators (e.g., the traffic patterns and/or characteristics thereof) from one or both ends of the communication session via the network slice 160 to detect and address anomalies, e.g., malicious activities or other activities that may be detrimental to the communication service provider network 101. For instance, DSM 199 may ensure that the slice 160 is being used (e.g., instantiating the network slice without data traffic that may be indicative of a denial of service (DoS attack)). In one example, the DSM 199 may also ensure that components of the network slice along the way do not alter the data traffic or act as a blackhole, e.g., by confirming that the data traffic sent by UE 104 is received in the same form by the one of the server(s) 185 in accordance with the respective performance indicators collected from the respective ends (and vice versa). In one example, the DSM 199 may also compare the usage of the current network slice 160 to historic or current usage and traffic patterns for other clients to the same server or similar servers, e.g., via one or more other network slices. For instance, a deviation in utilization of the subject network slice 160 as compared to similar slices may indicate that UE 104 and/or the one of the server(s) 185 is just holding slicing resources without actually utilizing them fully. Likewise, in one example, the DSM 199 may compare the traffic patterns and data volume across the subject network slice 160 to slice dedicated resources to ensure there is no resource overcommitting issues, which may be malicious or which may be the result of a misconfiguration of an application on UE 104, a misconfiguration of the one of the server(s) 185, etc.

Alternatively, or in addition, DSM 199 may implement one or more machine learning models (MLMs) that are configured to detect conditions for which a network slice with improved QoS may be needed by one or more UEs. For instance, such an MLM may generate an output indicating whether a need for a network slice exists, and what parameters the network slice may need to satisfy in terms of network service, e.g., in response to an input vector comprising the performance data from the access network 120, the cellular core network 130, conditions in the physical location of the UE 104 (e.g., presence of larger crowds, emergency conditions, weak signal strength, or the like), and/or the type of service or application the UE 104 is attempting to access (e.g., whether the service or application requires the transmission of potentially sensitive data).

In one example, the input vector may further include performance data from other network slices (e.g., slices that may be geographically related, slices that may have NFs (e.g., VNFs) existing on overlapping or partially overlapping sets of host devices/NFVI, slices that may be for the same server but with a different client and/or for a different but similar server, and so forth). Such an MLM may be retrained periodically or otherwise with additional training data comprising performance data from other network slices (e.g., slices that may be geographically related, slices that may have NFs (e.g., VNFs) existing on overlapping or partially overlapping sets of host devices/NFVI, slices that may be for the same server but with a different client and/or for a different but similar server, and so forth).

In this regard, it should be noted that in one example, DSM 199 may implement one or more machine learning algorithms (MLAs), e.g., one or more trained machine learning models (MLMs) for distributed radio resource orchestration for network slicing in accordance with the present disclosure. For instance, the MLA (or the trained MLM) may comprise a deep learning neural network, or deep neural network (DNN), such as convolutional neural network (CNN), a generative adversarial network (GAN), a language model, or “large language model” (LLM) such as a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In still other examples, DSM 199 may implement one or more network slicing MLMs comprising a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on.

The foregoing is just one example of distributed radio resource orchestration for network slicing. Thus, it should be appreciated that other, further, and different examples may readily be devised in accordance with the present disclosure. For instance, in another example, one of the server(s) 185 may initiate the creation of slice 160. In one example, this may be in the context of an ongoing PDN session for UE 104 communicating with the one of the server(s) 185, e.g., where a switch/transfer/upgrade to a new slice may be warranted, and/or may be in the context of a new PDN session establishment. Alternatively, or in addition, analysis of network performance data related to slice 160 (and other slices), remedial actions, or other aspects described above with respect to DSM 199 may be performed at NSMF 192 (and/or in one example, at SMOs 190, 191, or 195

In still another example, DSMs 194, 196, and 199 and/or SMOs 190, 191, and 195 may request and/or subscribe to various information that may be obtained and stored by NSMF 192. Alternatively, or in addition DSMs 194, 196, and 199 and/or SMOs 190, 191, and 195 may obtain various information from RAN components or other network elements directly (e.g., without NSMF 192 as an intermediary). In one example, DSMs 194, 196, and 199 and/or SMOs 190, 191, and 195 may subscribe to or otherwise obtain network anomaly alerts, reports, or the like from NSMF 192. In such case, DSMs 194, 196, and 199 and/or SMOs 190, 191, and 195 may then implement one or more rule sets and/or MLMs to determine whether and when to instantiate a new network slice, to determine the type of network slice and/or characteristics of the new network slice, etc.

Accordingly, DSMs 194, 196, and 199 and/or SMOs 190, 191, and 195 may then configure/reconfigure one or more aspects of access networks 120, 125, 127, cellular core network 130, and/or one or more network slices deployed over the infrastructure of access networks 120, 125, 127 and cellular core network 130, e.g., to implement the new network slice. In one example, DSMs 194, 196, and 199 and/or SMOs 190, 191, and 195 may accomplish this directly. In this regard, DSMs 194, 196, and 199 and/or SMOs 190, 191, and 195 may comprise all or a portion of a computing device or system, such as computing system 300, and/or processing system 302 as described in connection with FIG. 3 below, and may be configured to perform various operations in connection with examples of the present disclosure for distributed radio resource orchestration for network slicing (e.g., as illustrated and described in connection with the example of FIG. 2).

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions. In addition, network elements or functions that are illustrating as being deployed in one portion of the communication service provider network 101 may alternatively or additionally be deployed in another portion of the communication service provider network 101. For example, SMO 190 may be deployed in cellular core network 130, within access networks 120, 125, and 127, or may comprise a distributed computing platform having hardware components within cellular core network 130 and access network 120, 125, and 127. Thus, these and other modifications are all contemplated within the scope of the present disclosure.

FIG. 2 illustrates a flowchart of an example method 200 for distributed radio resource orchestration for network slicing, in accordance with the present disclosure. In one example, steps, functions and/or operations of the method 200 may be performed by a device as illustrated in FIG. 1, e.g., a distributed slicing manager, such as DSM 194, 196, or 199, or collectively via a plurality devices in FIG. 1, such as DSMs 194, 196, and/or 199 working in conjunction with any one or more other components in FIG. 1, such as slice orchestrator 193, NSMF 192, SMO 190, 191, 195, or the like, components of access networks 120, 125, and 127 (e.g., cell sites 121-124 and 128, BBU pool 126, etc.) and/or other components of cellular core network 130 (e.g., NSSF 136, slice infrastructure, e.g., slice 160, AMF 135, SMF 137, UPF 139, etc.), and so forth. In one example, the steps, functions, or operations of method 200 may be performed by a computing device or system 300, and/or a processing system 302 as described in connection with FIG. 3 below. For instance, the computing device 300 may represent at least a portion of a distributed slicing manager in accordance with the present disclosure. For illustrative purposes, the method 200 is described in greater detail below in connection with an example performed by a processing system, such as processing system 302.

The method 200 begins in step 202 and proceeds to step 204. In step 204, the processing system may detect, from within a radio access network of a communication service provider network, a need of a user endpoint device to access an improved quality of service.

In one example, the radio access network may be a cloud RAN, or an open RAN, and the processing system may be deployed in a component of the RAN. For instance, in one example, the processing system may be deployed as part of a RIC and may be configured to perform slicing of the communication service provider network in a distributed manner (e.g., in coordination with one or more other, similarly configured processing systems).

In one example, the need of the user endpoint device for access to an improved QoS may be automatically detected by the processing system. For instance, the processing system may execute a machine learning model that predicts when the user endpoint needs access to the improved QoS. The machine learning model may continuously receive inputs related to, e.g., the physical location of the user endpoint device, network conditions of the communication service provider network (e.g., traffic volume, throughput, latency, packet loss, etc.), sensor inputs from the user endpoint device and/or connected devices (e.g., biometric devices that monitor a user's heart rate, blood glucose levels, gait, and/or other health indicators), environmental conditions (e.g., weather, road conditions, and the like) in the physical locations served by the communication service provider network, events (e.g., concerts, sports events, conventions, festivals, and the like) in the physical locations served by the communication service provider network, and/or other data from third party data sources (e.g., first responder sources, news sources, social media, drones, and the like). Based on these inputs (and optionally on historical patterns), the machine learning model may predict when the user endpoint device is likely to need access to an improved QoS.

For instance, the processing system may detect that a current physical location of the user endpoint device is within or close to a physical location that is associated with higher than usual (e.g., based on historical patterns) RAN traffic. As an example, the processing system may detect that the user endpoint device is currently located at a stadium where a large concert or sports event is currently occurring. In this case, base stations of the RAN that are serving the geographic area of the stadium may see an increase in the amount of traffic that passes through this geographic area.

In another example, the processing system may detect that the current physical location of the user endpoint device is within or close to a physical location where reliable connectivity is particularly crucial. For instance, the processing system may detect that the current location of the user endpoint device is within a geographic area that has been affected by a natural disaster (e.g., earthquake, tornado, etc.), a traffic accident, or the like. In this case, the user endpoint device may require reliable connectivity to contact emergency services.

In a further example, the processing system may detect that the user endpoint device is part of a first responder system. In this case, the processing system may determine that the improved QoS is needed by the user endpoint device whenever the user endpoint device receives an incoming communication.

In another example, the processing system may detect that the user endpoint device is involved in a type of communication session for which the improved QoS has been predefined. For instance, communications between a specific group of user endpoint devices may always be eligible for the improved QoS, or communications that originate from a specific location during certain hours (e.g., an office building during business hours) may always be eligible for the improved QoS.

In another example, the need of the user endpoint device for access to the improved QoS may be detected when the user endpoint device sends a request for an improved QoS. For instance, a user of the user endpoint device may selectively request an improved QoS. As an example, a family may be traveling in a car along the highway, and the children may be playing video games in the back seat that require relatively high bandwidth. In this case, a parent may request that the QoS for the children's gaming devices be temporarily uplifted.

In optional step 206 (illustrated in phantom), the processing system may confirm, in response to the detecting, that the user endpoint device is eligible to receive the improved quality of service. As discussed above, in some cases, a user of the user endpoint device may request a temporary uplift of the QoS. In one example, an operator of the RAN may provide the ability to request a temporary QoS uplift, on demand, as part of a subscription service. Thus, if the processing system receives a request from the user endpoint device in step 206 that requests for an uplifted QoS, the processing system may contact the AMF of a cellular core network of the communication service provider network (which may in turn query a PCF of the communication service provider core network) to confirm the subscription data associated with the user endpoint device and/or any policies that may apply to the user endpoint device.

In optional step 208 (illustrated in phantom), the processing system may confirm, in response to the detecting, that a network slice is capable of providing the requested improved quality of service. It should be noted than in some cases, the processing system may determine that a network slice is not needed. For instance, although circumstances may be present (e.g., based on user endpoint device location, user request, occurrence of an emergency, etc.) that would normally trigger the definition of a network slice for one or more user endpoint devices, if the network slice would not provide QoS that is improved relative to the QoS that the user endpoint devices are currently experiencing, then the processing system may elect not to define a network slice.

In one example, the processing system may simulate, in response to the detecting, an instance of end-to-end traffic in a proposed network slice. Based on the simulation, the processing system may determine the QoS (e.g., in terms of throughput, bandwidth, latency, packet loss, and/or other metrics) that the user endpoint device is likely to experience if served by the proposed network slice. If the QoS that the user endpoint device is likely to experience if served by the proposed network slice is not an improvement over the current QoS that the user endpoint device is experiencing (e.g., not an improvement by at least a threshold measure of one or more metrics), then the processing system may determine that the proposed network slice is not needed and may take no further action.

In step 210, the processing system may define, in response to the detecting and in coordination with at least one other processing system in the radio access network, a set of radio resources to support the improved quality of service for the user endpoint device. In one example, the set of radio resources may comprise a network function resource allocation of an AMF, a SMF, and a UPF. In one example, the set of radio resources may further comprise a network resource allocation of at least one RAN component, e.g., a CU, a DU, and/or a RU, etc. In one example, the set of radio resources may further comprise a network resource allocation of one or more transport network components, e.g., intermediate devices between the RAN and the cellular core network, or the like.

In one example, the processing system may be one of a plurality of similarly configured processing systems distributed throughout the RAN and throughout other RANs of the communication service provider network. The plurality of processing systems may form clusters that cooperate to support larger slices capable of supporting larger numbers of user endpoint devices over larger geographic areas. For instance, five open RANs that server geographic areas located in proximity to each other may cooperate to define a slice that can support one hundred or more user endpoint devices. Thus, when users move about the geographic area, they may still continue to receive improved QoS via the same slice features, as long as the users are located within the serving area of one of the open RANs (and as long as the circumstances that led to the need for the improved QoS are still present).

In one example, the processing systems may form the clusters dynamically, based on learning circumstances that may demand definition of network slices. For instance, one processing system may be located to serve an area that borders a shopping mall on one side and a forest on an opposite side. In this case, it may make more sense for the processing system to form a cluster with another processing system that serves an area bordering the shopping mall (where user endpoint devices are more likely to be present), rather than another processing system that serves an area bordering the forest (where user endpoint devices may be less likely to be present). It should be noted that any of the processing systems may belong to more than one cluster.

In one example, defining the slice may involve coordinating with virtual CUs, virtual DUs, and/or other devices in the RAN, as well as with a slice orchestrator in the cellular core network, to provide the set of radio resources. In one example, the processing system may predefine sets of radio resources to support circumstances that meet some predefined criteria. For instance, if certain criteria with respect to user endpoint device mobility, network conditions, environmental conditions, and/or other circumstances are satisfied, then a predefined set of radio resources may be allocated to define a slice to support user endpoint devices that are affected.

In step 212, the processing system may configure the set of radio resources as a slice of the communication service provider network. In one example, the size of the slice (e.g., in terms of the number of users who can be supported by the slice) is variable. For instance, a slice that is defined to support an improved QoS during a concert at a stadium may be larger than a slice that is defined to support a request for on-demand QoS uplift from a single user.

In step 214, the processing system may send an instruction to the user endpoint device that causes the user endpoint device to connect to the slice. For instance, the processing system may instruct the user endpoint device to begin transmitting and/or requesting data packets over the network slice. The method 200 may end in step 216.

It should be noted that the method 200 may be expanded to include additional steps or may be modified to include additional operations with respect to the steps outlined above. For example, various steps of the method 200 may be repeated for the same or different communication system(s) for establishing subsequent network slices for other user endpoint devices, or for instructing additional user endpoint devices to connect to an established network slice. In one example, the method 200 may alternatively or additionally include collecting one or more training data sets from network slices of the communication service provider network, and then training one or more machine learning models as described above using the training data set(s). Alternatively, or in addition, the method 200 may further include determining one or more rule-based thresholds for defining network slices, e.g., using the same or similar historic network performance data relating to various existing network slices. In one example, the method 200 may be expanded or modified to include steps, functions, and/or operations, or other features described above in connection with the example(s) of FIG. 1, or as described elsewhere herein. Thus, these and other modifications are all contemplated within the scope of the present disclosure.

In addition, although not specifically specified, one or more steps, functions, or operations of the example method 200 may include a storing, displaying, and/or outputting step as required for a particular application. In other words, any data, records, fields, and/or intermediate results discussed in a respective method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for distributed radio resource orchestration for network slicing, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 306 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 305 for distributed radio resource orchestration for network slicing (e.g., a software program comprising computer-executable instructions) can be loaded into memory 304 and executed by hardware processor element 302 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for distributed radio resource orchestration for network slicing (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system including at least one processor from within a radio access network of a communication service provider network, a need of a user endpoint device to access an improved quality of service;
defining, by the processing system in response to the detecting and in coordination with at least one other processing system in the radio access network, a set of radio resources to support the improved quality of service for the user endpoint device;
configuring, by the processing system, the set of radio resources as a slice of the communication service provider network; and
sending, by the processing system, an instruction to the user endpoint device that causes the user endpoint device to connect to the slice.

2. The method of claim 1, wherein the processing system is part of a distributed slicing manager implemented in a radio access network intelligent controller of the radio access network.

3. The method of claim 2, wherein the at least one other processing system comprises another distributed slicing manager implemented in another radio access network intelligent controller of the radio access network.

4. The method of claim 3, wherein the distributed slicing manager and the another distributed slicing manager are members of a cluster containing a plurality of distributed slicing managers implemented on a plurality of radio access network intelligent controllers of the radio access network.

5. The method of claim 4, wherein the cluster is formed dynamically by the plurality of distributed slicing managers, based on the plurality of distributed slicing managers serving neighboring geographic areas.

6. The method of claim 5, wherein the plurality of distributed slicing managers cooperates to provide the set of radio resources as a physical location of the user endpoint device moves through a geographic area served by the radio access network.

7. The method of claim 1, wherein the need of the user endpoint device for access to the improved quality of service is automatically detected by the processing system based on data including at least one of: a physical location of the user endpoint device, a network condition of the communication service provider network, a sensor input from the user endpoint device, a sensor input from connected devices, an environmental condition in a physical location served by the communication service provider network, an event occurring in the physical location served by the communication service provider network, or data from third party data.

8. The method of claim 7, wherein the processing system executes a machine learning model that predicts the need of the user endpoint device for access to the improved quality of service in response to the data.

9. The method of claim 8, wherein the machine learning model further predicts the need of the user endpoint device for access to the improved quality of service based on a historical pattern.

10. The method of claim 1, wherein the need of the user endpoint device for access to the improved quality of service is detected by the processing system when the user endpoint device sends a request for the improved quality of service.

11. The method of claim 10, further comprising, after the detecting but prior to the defining:
confirming, by the processing system in response to the detecting, that the user endpoint device is eligible to receive the improved quality of service.

12. The method of claim 1, further comprising, after the detecting but prior to the defining:
confirming, by the processing system, that an existing network slice is capable of providing the improved quality of service relative to a current quality of service currently being experienced by the user endpoint device.

13. The method of claim 1, wherein the set of radio resources comprises a network resource allocation of at least one radio access network component.

14. The method of claim 13, wherein the at least one radio access network component comprises at least one of: a centralized unit, a distributed unit, or a radio unit.

15. The method of claim 14, wherein the set of radio resources further comprises a network resource allocation of at least one cellular core network component.

16. The method of claim 15, wherein the at least one cellular core network component comprises at least one of: an access and mobility management function, a session management function, or a user plane function.

17. The method of claim 16, wherein the set of radio resources further comprises a network resource allocation of at least one transport network component.

18. The method of claim 1, wherein the set of radio resources is predefined by the processing system to support a circumstance that meet a predefined criterion, and the need of the user endpoint device to access the improved quality of service meets the predefined criterion.

19. A non-transitory computer readable storage medium storing instructions which, when executed by a processing system including at least one processor, cause the processing system to perform operations, the operations comprising:
detecting, from within a radio access network of a communication service provider network, a need of a user endpoint device to access an improved quality of service;
defining, in response to the detecting and in coordination with at least one other processing system in the radio access network, a set of radio resources to support the improved quality of service for the user endpoint device;
configuring the set of radio resources as a slice of the communication service provider network; and
sending an instruction to the user endpoint device that causes the user endpoint device to connect to the slice.

20. An apparatus comprising:
a processing system including at least one processor; and
a non-transitory computer-readable medium storing instructions which, when executed by the processing system, cause the processing system to perform operations, the operations comprising:
detecting, from within a radio access network of a communication service provider network, a need of a user endpoint device to access an improved quality of service;
defining, in response to the detecting and in coordination with at least one other processing system in the radio access network, a set of radio resources to support the improved quality of service for the user endpoint device;
configuring the set of radio resources as a slice of the communication service provider network; and
sending an instruction to the user endpoint device that causes the user endpoint device to connect to the slice.
